(19) United States
(12) Patent Application Publication
(10) Pub. No.: US 2025/0385528 A1
(43) Pub. Date: Dec. 18, 2025

(54) PRE-CHARGE CONTROLLER FOR HIGH VOLTAGE BATTERY APPLICATIONS

(71) Applicant: Analog Devices, Inc., Wilmington, MA (US)

(72) Inventors: Mudit KHANNA, Wilmington, MA (US); Pankaj KASHIKAR, Wilmington, MA (US)

(21) Appl. No.: 19/242,682

(22) Filed: Jun. 18, 2025

Related U.S. Application Data
(60) Provisional application No. 63/661,455, filed on Jun. 18, 2024.

(51) Int. Cl. H02J 7/00

(52) U.S. Cl. CPC H02J 7/00308; H02J 7/0031; H02J 7/007182; H02J 7/007188; H02J 2207/50

(57) ABSTRACT

Example implementations include a method, apparatus and integrated circuit (IC) for active pre-charging a battery system. The IC may include a pre-charging controller configured to manage pre-charging of a capacitive load. The IC may include a programmable current control module configured to maintain constant charging current based on one or more parameters from the pre-charging controller. The IC may include a smart gate driver configured to drive one or more high voltage field-effect transistors (FETs) based on one or more control signals from the pre-charging controller. The IC may include a boundary mode controller configured to configure inductor current to maintain constant charging current. The IC may include a safety monitoring module configured to detect an overvoltage or undervoltage state based on system voltage monitoring. The IC may include a timing module configured to indicate a charge completion following a defined charge time.

### RELATED APPLICATIONS

This application claims the benefit of U.S. Patent Application Ser. No. 63/661,455, entitled “PRE-CHARGE CONTROLLER FOR HIGH VOLTAGE BATTERY APPLICATIONS” and filed on Jun. 18, 2024, which is assigned to the assignee hereof, and incorporated herein by reference in its entirety.

### TECHNICAL FIELD

Aspects of the present disclosure relate generally to a pre-charge controller for high voltage battery applications.

### BACKGROUND

The battery storage technology is increasing in its adoption across multiple industries ranging from electric cars to solar power. In all these high voltage battery systems, battery monitoring (BMS) integrated circuits (ICs) are used to protect regulate the cell balancing. Along with these BMS systems, relays and contactors are used as a protection device to disconnect the downstream loads. At the end of the battery pack, before the loads, a large capacitor is typically present to filter the noise from loads. During the start-up of the system, the contactors are closed to connect battery to the cap. However, without any resistance in the path, closing the contactors would cause a surge in current. In the current implementation, a resistor is used in series with a contactor to first pre-charge the bulk capacitor before turning ON the main relay. This method of charging the capacitor is slow, bulky and costly.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

An example aspect includes integrated circuit (IC) for active pre-charging a battery system. The IC may be configured to a pre-charging controller configured to manage pre-charging of a capacitive load. The IC may be configured to a programmable current control module configured to maintain constant charging current based on one or more parameters from the pre-charging controller. The IC may be configured to a smart gate driver configured to drive one or more high voltage field-effect transistors (FETs) based on one or more control signals from the pre-charging controller. The IC may be configured to a boundary mode controller configured to configure inductor current to maintain constant charging current based on feedback from the programmable current control module. The IC may be configured to a safety monitoring module configured to detect an overvoltage or undervoltage state based on system voltage monitoring. The IC may be configured to a timing module configured to indicate a charge completion following a defined charge time associated with the pre-charging of the capacitive load.

Another example aspect includes an apparatus for active pre-charging a battery system. The apparatus may include means for means for managing pre-charging of a capacitive load. The apparatus may include means for maintaining constant charging current based on one or more parameters from the pre-charging controller. The apparatus may include means for driving one or more high voltage field-effect transistors (FETs) based on one or more control signals from the pre-charging controller. The apparatus may include means for configuring inductor current to maintain constant charging current based on feedback from the programmable current control module. The apparatus may include means for detecting an overvoltage or undervoltage state based on system voltage monitoring. The apparatus may include means for indicating a charge completion following a defined charge time associated with the pre-charging of the capacitive load.

Another example aspect includes a method of active pre-charging a battery system. The method may include managing pre-charging of a capacitive load. The method may further include maintaining constant charging current based on one or more parameters from the pre-charging controller. The method may further include driving one or more high voltage field-effect transistors (FETs) based on one or more control signals from the pre-charging controller. The method may further include configuring inductor current to maintain constant charging current based on feedback from the programmable current control module. The method may further include detecting an overvoltage or undervoltage state based on system voltage monitoring. The method may further include indicating a charge completion following a defined charge time associated with the pre-charging of the capacitive load.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1A is a circuit diagram for a pre-charging a battery system, in accordance with various implementations of the present disclosure;

FIG. 1B is a diagram of an example small outline integrated circuit, in accordance with various implementations of the present disclosure;

FIG. 2A is an internal block diagram for active pre-charging of a battery system, in accordance with various implementations of the present disclosure;

FIG. 2B is a turn-off time (TOFF) block diagram, in accordance with various implementations of the present disclosure;

FIG. 3 is a further circuit diagram for a pre-charging a battery system, in accordance with various implementations of the present disclosure;

FIG. 4 is a further circuit diagram for a passive pre-charging a battery system, in accordance with various implementations of the present disclosure;

FIG. 5 is a further circuit diagram for an active pre-charging a battery system, in accordance with various implementations of the present disclosure;

FIG. 6 is a graph diagram showing the difference between a passive and active charging, in accordance with various implementations of the present disclosure; and

FIG. 7 is a flowchart of an example of pre-charging a battery system, in accordance with various implementations of the present disclosure.

### DETAILED DESCRIPTION

Aspects of the present disclosure are directed to an active pre-charge controller for high voltage battery applications. Specifically, the present disclosure provides integrated active pre-charging controller for high voltage battery systems, such as those used in electric and hybrid electric vehicles associated with Automotive Safety Integrity Level B (ASIL-B) compliance. ASIL-B may represent a moderate level of risk and safety requirements for automotive electronic and electrical systems. In the context of high voltage battery systems and pre-charge controller integrated circuits (ICs), ASIL-B compliance may ensure that the device incorporates specific safety mechanisms and design features to mitigate risks associated with electrical faults, component failures, and hazardous operating conditions.

ASIL-B compliance in high voltage battery systems and pre-charge controller ICs may involve the integration of several safety and reliability features. To ensure reliable operation even in the presence of certain faults, redundant safety circuits such as precision bandgap references may be implemented. The device may incorporate dedicated fault indicators and diagnostic functions, which are beneficial for detecting and reporting abnormal conditions like overcurrent, undervoltage, or gate driver faults. Protection mechanisms may also be implemented, including overcurrent protection, thermal shutdown, undervoltage lockout (UVLO), and gate open or short detection, all of which may work together to prevent unsafe operation.

System monitoring may be achieved through the use of integrated current sense amplifiers and programmable current limits, allowing for precise control and supervision of the pre-charge and discharge processes to ensure safe and controlled energy transfer. High-voltage isolation between the control and power domains may be provided to protect low-voltage circuits and users from high-voltage hazards. Furthermore, ASIL-B compliance provides the ability to operate over a wide temperature range, typically from −40° C. to +150° C., to meet the stringent reliability and safety requirements of automotive applications. By incorporating these features, the pre-charge controller IC may be used in safety-critical automotive environments, such as electric and hybrid electric vehicle battery management systems, where moderate risk reduction measures are necessary to ensure functional safety and protect against potential hazards.

The present implementations set forth an active pre-charging controller that manages and optimizes the charging of high voltage capacitive loads by using an integrated control IC and smart gate driver to safely and efficiently limit inrush current, reduce charging time, and provide advanced safety and diagnostic features for high voltage battery systems. The active pre-charging controller overcomes the limitations of the passive pre-charging methods, which rely on bulky and expensive contactors and resistors, with implementations that utilize a control IC and high voltage field-effect transistors (FETs). The active pre-charging controller provides several advantages, including reduced charging times-up to 60% faster than passive methods—by maintaining a constant current profile during the charging process. The active pre-charging controller may incorporate a smart gate driver compatible with various FET technologies, such as SiC, Si-MOSFET, and IGBT, and features programmable current control, adjustable frequency, and charge complete indication.

The pre-charge controller IC may provide safety mechanisms, including ASIL-B compliance, redundant bandgap references for overvoltage and undervoltage monitoring, fault diagnostics, desaturation (DESAT) protection, and Miller clamp protection. The pre-charge controller IC may also provide programmable fault indicators, such as an extended charge time fault, which ensures the system is turned off if charging is not completed within a specified period. The boundary mode control technique may allow for smaller magnetics, reducing system cost and size, while eliminating the need for high-side current sensing. By actively monitoring input and output voltages, the pre-charge controller IC may optimize the charging cycle, prevents current shoot-through, and minimizes power dissipation. These advantages collectively enhance system reliability, safety, and efficiency, making the pre-charge controller IC well-suited for demanding automotive and industrial high voltage applications.

As such, the implementations set forth herein relate to an IC for active pre-charging a battery system. The IC may include a pre-charging controller configured to manage pre-charging of a capacitive load. The IC may further include a programmable current control module configured to maintain constant charging current based on one or more parameters from the pre-charging controller. The IC may further include a smart gate driver configured to drive one or more high voltage FETs based on one or more control signals from the pre-charging controller. The IC may further include a boundary mode controller configured to configure inductor current to maintain constant charging current based on feedback from the programmable current control module. The IC may further include a safety monitoring module configured to detect an overvoltage or undervoltage state based on system voltage monitoring. The IC may further include a timing module configured to indicate a charge completion following a defined charge time associated with the pre-charging of the capacitive load.

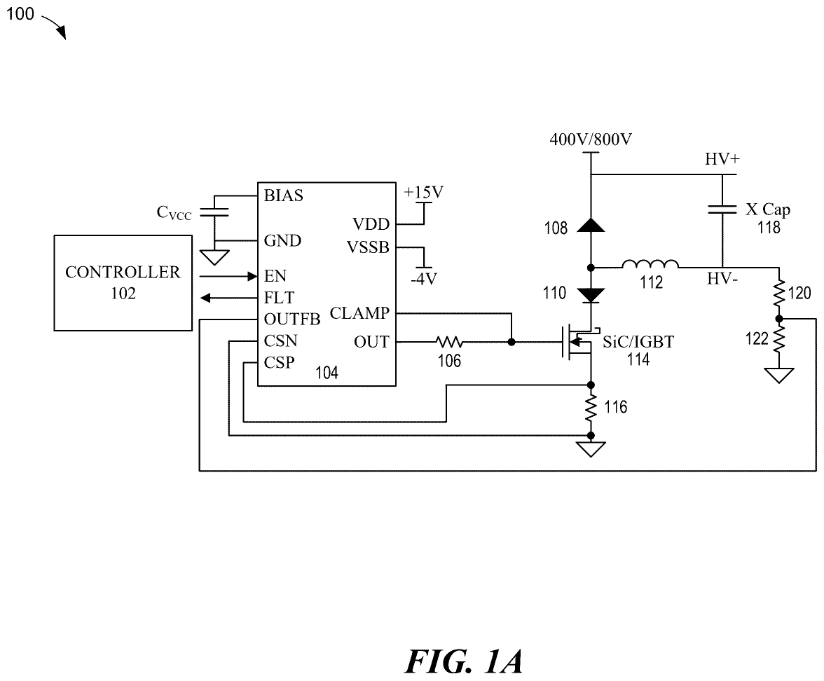

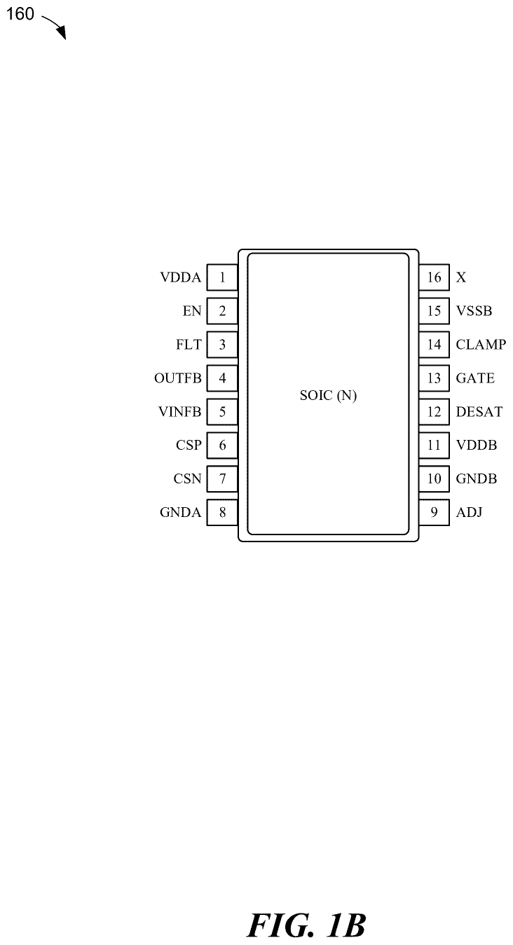

The described features will be presented in more detail below with reference to FIGS. 1-7.

FIG. 1A is a circuit diagram for a pre-charging active battery system 100. The pre-charging active battery system 100 may include controller 102 and IC 104, which may be an small outline integrated circuit (SOIC). The pre-charging active battery system 100 may include resistor 106, 116, 120 and 122. The pre-charging active battery system 100 may also include SiC/IGBT transistor 114 and inductor 112. The pre-charging active battery system 100 may also include diodes 108 and 110. The pre-charging active battery system 100 may also include capacitors such as XCap 118 and CVCC.

The active pre-charging controller IC 104 may have a range of pins that serve specific functions to ensure safe and efficient operation within high voltage battery systems. The BIAS pin may supply the necessary bias voltage to power the internal circuitry of the IC, ensuring stable and reliable performance. The GND pin may act as the primary reference point for all voltages in the circuit, providing a stable ground connection for proper current return paths. The EN, or enable, pin may allow for external control of the pre-charging process; when a logic high signal is applied, the active pre-charging controller IC 104 is activated and begins the pre-charging sequence, which is essential for system-level control and safety interlocks. The FLT pin may be used to indicate fault conditions such as overvoltage, undervoltage, or extended charge time, and it is typically connected to a system controller or indicator to alert users or trigger protective actions.

The OUTFB, or output feedback, pin monitors the voltage at the output of the pre-charging circuit, usually across the high voltage capacitor, and provides critical feedback to the controller. This allows the active pre-charging controller IC 104 to determine when the pre-charging process is complete or if abnormal conditions are present. The CSN (current sense negative) and CSP (current sense positive) pins are connected across a current sense resistor or shunt in the pre-charging path, enabling the IC to accurately monitor the charging current. This precise current sensing may be beneficial for current control and protection against overcurrent events.

The VDD pin may supply the main operating voltage to the IC, powering the internal logic and gate driver circuits, and is typically connected to a voltage source in the range of 12V to 28V, depending on the FET technology in use. The VSSB pin serves as a secondary ground reference, often for the isolated gate driver section, ensuring proper isolation and safety between high and low voltage domains. The CLAMP pin may be associated with Miller clamp protection, which helps prevent unwanted turn-on of the power FET due to voltage transients by stabilizing the gate during switching events. Finally, the OUT pin is responsible for driving the gate of the external high voltage FET, such as a SiC, Si-MOSFET, or IGBT, delivering the necessary gate drive voltage and current to switch the device on and off during pre-charging.

The SiC/IGBT may serve as the main power switching device in the pre-charging path. The gate of this device is driven by the OUT pin of the controller IC, and these transistors are selected for their high efficiency, fast switching capabilities, and ability to handle the high voltages and currents typical in electric vehicle and hybrid electric vehicle battery systems. The Xcap, or high voltage capacitor, represents the large input capacitor bank that must be pre-charged when the system is powered up. The pre-charging controller IC 104 may manage the current flowing into this capacitor, preventing damaging inrush currents and ensuring a controlled, safe charging process. This combination of intelligent pin functions and robust circuit components enables the pre-charging controller to deliver a compact, efficient, and highly reliable solution for demanding high voltage applications.

When the system is powered on and the EN pin is activated, the active pre-charging controller IC 104 may begin the pre-charging process by turning on the SiC/IGBT through the OUT pin. The current flowing into the Xcap may be monitored via the CSP and CSN pins, allowing the controller to regulate the charging current and prevent excessive inrush. The OUTFB pin provides feedback on the voltage across the Xcap, enabling the controller to determine when the capacitor is fully charged. If any fault conditions are detected, such as overcurrent, overvoltage, or an incomplete charge within a specified time, the FLT pin is asserted to signal a fault, and the controller can disable the gate drive to the SiC/IGBT for safety. The CLAMP pin ensures that the gate of the power FET remains stable and protected from voltage spikes during switching events. The BIAS, VDD, and VSSB pins ensure the active pre-charging controller IC 104 and its gate driver section are properly powered and referenced.

FIG. 1B is a diagram of an example SOIC 160. The SOIC 160 corresponds to or may be integrated as part of a pre-charge controller IC for high voltage battery applications, such as those found in electric vehicles and hybrid electric vehicles. The SOIC 160 may integrate both an isolated gate driver and a pre-charge controller, providing robust control, protection, and isolation for managing the pre-charging of large bulk capacitors in high voltage battery systems. Each of the 16 pins on the SOIC 160 package may serve a distinct function within the overall circuit to ensure safe, efficient, and reliable operation in compliance with ASIL-B.

The VDDA pin may be the primary analog supply voltage input, delivering power to the analog and control circuitry within the IC. The EN (Enable) pin may be a digital input that allows the user to activate or deactivate the IC, providing a means for system-level control and safety interlocks. The FLT (Fault) pin may be an output that signals the presence of fault conditions, such as overcurrent, undervoltage, or thermal events, thereby enabling the system to respond appropriately to protect both the IC and the connected power components. The FB (Feedback) pin may be used to monitor the output voltage or current, allowing the controller to regulate the pre-charge process and ensure the bulk capacitor is charged to the correct level.

The VIN pin may be the main input voltage supply for the IC, powering the internal circuitry and supporting the operation of the gate driver and pre-charge controller. The CSP (Current Sense Positive) and CSN (Current Sense Negative) pins may be differential inputs connected across a current sense resistor or shunt, enabling precise measurement of the pre-charge current. This differential sensing capability may allow the IC to implement accurate current control and protection features. The GNDA pin may be the analog ground reference for the low voltage side of the IC, ensuring stable operation and minimizing noise interference for sensitive analog signals.

The two X pins labeled may be reserved for no-connect (NC) or future functionality. The VSSB pin may be the isolated ground reference for the high voltage side of the system, providing galvanic isolation between the low voltage control domain and the high voltage power domain, which is essential for safety and system integrity. The CLAMP pin may offer an optional Miller clamp function, which helps to prevent unintended turn-on of the external power switch (such as a SiC or IGBT transistor) due to voltage transients or capacitive coupling, thereby enhancing the robustness and safety of the system.

The OUT pin may be the gate driver output, which directly controls the gate of the external SiC or IGBT transistor, turning it on and off as required to regulate the pre-charge current flowing into the bulk capacitor. The DESAT pin may be used for desaturation detection, providing protection against short-circuit or overcurrent conditions in the external power switch by monitoring the voltage across the device and triggering a fault response if an abnormal condition is detected. The VDDB pin may be the secondary or isolated supply voltage input, supplying power to the gate driver and other isolated circuitry on the high voltage side of the IC. The GNDB pin may service as the ground reference for the high voltage side, complementing VSSB and ensuring proper operation of the isolated circuitry. As such, the SOIC 160 may be used as an active pre-charge controller IC to deliver control, protection, and isolation in high voltage battery systems.

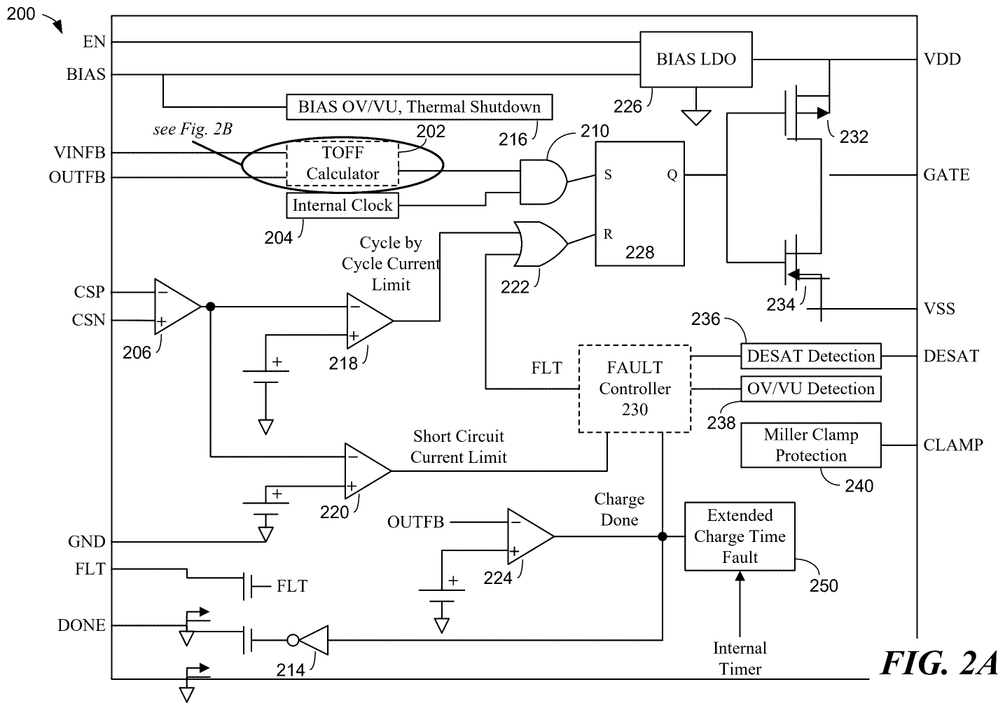

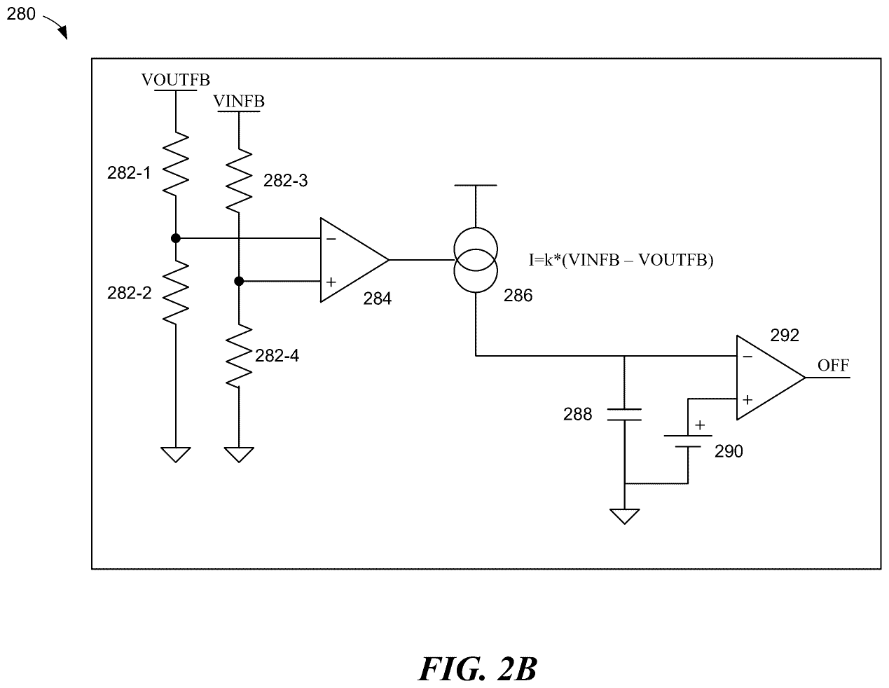

FIG. 2A is an internal block diagram for active pre-charging of a battery system 200. The active pre-charging system 200 may include TOFF calculator 202, internal clock 204, operational amplifiers 206, 218, 220, and 224, diode 214, AND gate 210, OR gate 222, Bias LDO 226, fault controller 230, extended charge time fault 250, transistors 232 and 234, DESAT detection 236, 0V/VU detection, and Miller Clamp Protection 240.

The internal architecture of the active pre-charging system 200 may be used for high voltage battery systems, such as those used in electric and hybrid vehicles. This integrated solution may be implemented to manage the pre-charging of large capacitive loads, ensuring system safety, reliability, and compliance with automotive safety standards. The active pre-charging of a battery system 200 provides analog and digital control blocks, protection circuits, and diagnostic features, all orchestrated to deliver precise and safe pre-charging.

The timing and switching logic of the active pre-charging system 200 may include the TOFF calculator 202, which may be configured to determine the appropriate off-time during each switching cycle. The TOFF calculator 202 actively monitors the voltage difference between the input (VINFB) and output (VOUTFB) feedback pins, which are connected across the inductor in the pre-charging path. By calculating the off-time based on real-time voltage conditions, the controller ensures boundary mode operation, which optimizes charging speed and minimizes power dissipation. The TOFF calculator 202 is connected to an internal clock 204, which provides the necessary timing signals for the switching operation. Both the TOFF calculator 202 and the internal clock feed into an AND gate, which synchronizes their outputs to control the switching events precisely. This arrangement prevents current shoot-through during startup and accelerates the switching frequency as the end of the charge approaches, ensuring efficient and safe pre-charging.

The active pre-charging system 200 includes a bias Low Dropout Regulator (LDO) 226, which generates a stable bias voltage for the internal analog and digital circuitry. The bias LDO 226 may be beneficial for maintaining consistent performance across a wide input voltage range, typically from 4.5V to 36V. This regulated bias voltage powers sensitive blocks such as the comparators, logic gates, and protection circuits, ensuring reliable operation even under varying supply conditions.

Multiple diodes are placed throughout the circuit to provide protection functions, such as blocking reverse currents, clamping voltage spikes, and ensuring correct current flow paths. The DESAT 236 detection circuit is a critical safety feature that monitors the voltage across the power switching device (such as a SIC MOSFET or IGBT). If the voltage exceeds a safe threshold, indicating a potential short circuit or device failure, the DESAT 236 detection triggers a fault response to protect the system.

Overvoltage (0V) and undervoltage (UV) detection 238 circuits continuously monitor the supply rails and output voltages. These comparators ensure that the system operates within safe voltage limits, and any deviation outside the specified range results in a fault indication and shutdown of the pre-charging process. The Miller clamp detection circuit 240 may be integrated to prevent unwanted turn-on of the power FET due to voltage transients, especially during high-speed switching. By clamping the gate voltage, this feature enhances the robustness and reliability of the gate drive.

Various transistors are implemented throughout the circuit to implement switching, amplification, and protection functions. The main power transistor, typically an N-channel SiC MOSFET or IGBT, is driven by the gate driver output of the controller. Additional transistors are used within the internal logic and protection circuits, such as those controlling the Miller clamp, DESAT detection, and fault signaling paths. These transistors are selected for their fast switching characteristics and ability to handle the high voltages and currents present in automotive battery systems.

Further, the fault controller 230 may be configured to actively monitor various parameters and responds to abnormal conditions, such as 0V/UV detection, DESAT detection, Miller clamp protection, and extended charge time fault. When any of the monitored parameters indicate a fault condition, the fault controller 230 may protect the system by, for example, disabling the gate driver to turn off the main power switching device, thereby halting the pre-charging process. The fault controller 230 may further activate a dedicated FAULT pin, which can be used by external systems or controllers to log the event, trigger alarms, or initiate further safety protocols. The fault controller 230 may further identify the nature and source of the fault based diagnostic information to help, aiding in system troubleshooting and maintenance.

The extended charge time fault indicator 250 corresponds to a programmable circuit monitors the duration of the pre-charging process and compares it to a user-defined maximum allowable time. If the charging is not completed within this period, the extended charge time fault circuit flags a fault condition and disables the controller. This mechanism prevents prolonged exposure to abnormal conditions, such as a failed capacitor or wiring issue, thereby enhancing system safety and reliability.

FIG. 2B is a detailed view of a turn-off time (TOFF) calculator circuit 280. The TOFF calculator circuit 280 may dynamically determine the appropriate off-time for the switching element (such as a MOSFET or IGBT) during each cycle of the pre-charging process. The TOFF calculator circuit 280 may be part of the active pre-charging controller's boundary mode operation, which is designed to optimize charging efficiency, minimize power dissipation, and enhance system safety.

The TOFF calculator circuit 280 may actively monitors the voltage difference between the input (VINFB) and output (VOUTFB) feedback nodes across the inductor in the pre-charging circuit. The TOFF calculator circuit 280 receives these two voltage signals and uses them to compute the off-time for the switching device. The calculation maybe based on the principle that the off-time should be adjusted in real-time according to the instantaneous voltage conditions, ensuring that the inductor current returns to zero before the next switching cycle begins. This approach is useful to boundary mode (also known as critical conduction mode) operation, where each switching cycle starts when the inductor current reaches zero, thereby preventing current shoot-through and reducing switching losses.

The TOFF calculator circuit 280 may use a relationship, which may be expressed as I=k*(VINFB−VOUTFB), where “k” is a proportionality constant. This relationship allows the controller to determine the rate at which the inductor current decays during the off-time. By continuously evaluating the voltage difference, the TOFF calculator circuit 280 dynamically adjusts the duration of the off period for each switching cycle. This ensures that the pre-charging current remains within safe and optimal limits, regardless of variations in load capacitance or supply voltage.

The TOFF calculator circuit 280 may be integrated with other safety and control features within the pre-charging controller. For example, the TOFF calculator circuit 280 may operate in conjunction with the fault controller to ensure that, in the event of a detected fault (such as overvoltage, undervoltage, or desaturation), the switching operation is immediately halted. Additionally, the TOFF calculator circuit's 280 real-time operation supports the programmable current control and charge time monitoring features, enabling the system to achieve faster and more reliable pre-charging cycles.

The use of a simplified TOFF calculator 280 may offer several advantages. The need for complex high-side current sensing circuits may be eliminated, thereby reducing system size, cost, and design complexity. The boundary mode operation enabled by the TOFF calculator allows for the use of smaller magnetic components, further lowering the overall system cost. Moreover, by ensuring precise control over the switching cycles, the TOFF calculator 280 may contribute to shorter charging times and improved energy efficiency, while maintaining robust protection for the high voltage system.

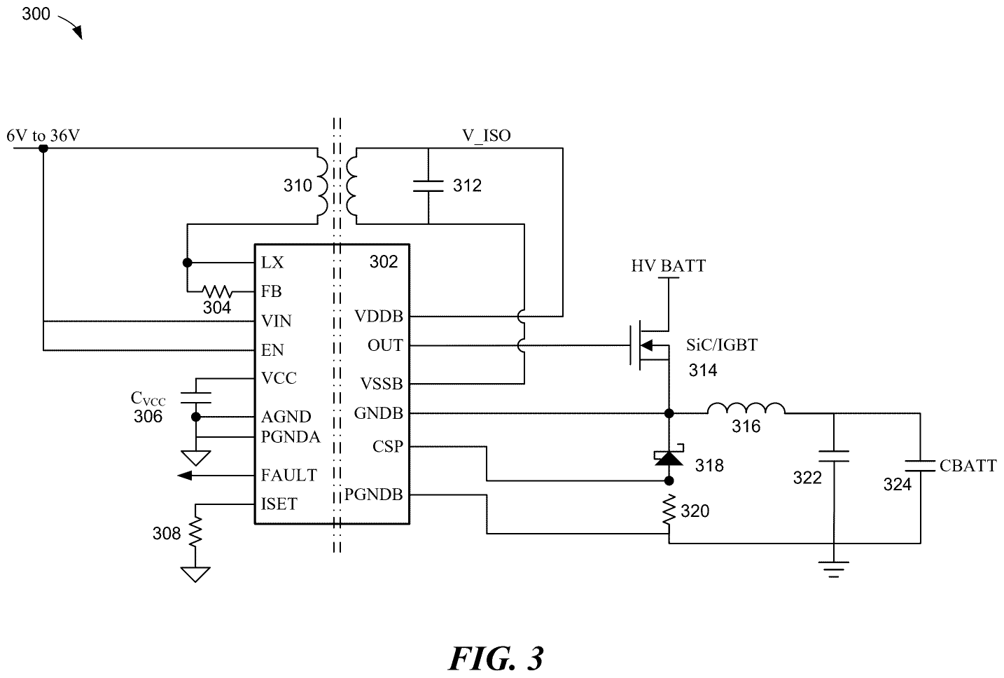

FIG. 3 is a further circuit diagram for a pre-charging system 300. FIG. 3 demonstrates an active pre-charging controller IC's 302 integration within the pre-charging system 300. The active pre-charging controller IC's 302 may include interconnection of various functional pins on the controller IC with external circuit components, including capacitors, resistors, power switches (such as SiC/IGBT devices), and an inductor. The implementation facilitates efficient and safe pre-charging of high voltage capacitive loads, such as those found in electric vehicle (EV) and hybrid electric vehicle (HEV) applications.

The LX pin may be connected to the switching node, which interfaces with the inductor and the power switch (SiC/IGBT). The FB (feedback) pin may be used to monitor the output voltage, providing real-time feedback to the controller for precise regulation of the pre-charging process. The VIN pin serves as the main input voltage supply to the controller, while the EN (enable) pin allows for external control of the pre-charging operation, enabling or disabling the circuit as needed.

The VCC pin may supply the necessary operating voltage to the controller's internal circuitry, and may be decoupled with a capacitor labeled CVCC to ensure stable operation and to filter out noise. AGND (analog ground) and PGNDA (power ground A) provide distinct ground references for the analog and power sections of the circuit, minimizing noise coupling and improving overall system stability. The FAULT pin may be dedicated to signaling fault conditions, such as overcurrent, overvoltage, or undervoltage events, allowing for rapid system response and protection.

The ISET pin may be used to set the desired pre-charging current, often through an external resistor that programs the current limit according to system requirements. VDDB supplies the gate driver voltage for the power switch, ensuring robust and efficient switching of the SiC/IGBT device. The OUT pin may be connected to the gate of the power switch, delivering the drive signal necessary for turning the device on and off during the pre-charging cycle. VSSB and GNDB may serve as additional ground references for the secondary side of the circuit, further isolating sensitive control signals from high current paths.

The CSP (current sense positive) pin may be connected to a current sensing element, such as a low-value resistor, which allows the controller to monitor the actual pre-charging current flowing through the inductor and into the load capacitor. PGNDB (power ground B) provides a return path for the high current side of the circuit, ensuring accurate current measurement and safe operation. The inductor, placed in series with the power switch and the load, plays a crucial role in shaping the pre-charging current profile, enabling the controller to implement boundary mode operation for optimal efficiency.

The pre-charging system 300 demonstrates the integration of external components such as CVCC (a decoupling capacitor for VCC), resistors for current setting and feedback, and the SiC/IGBT power switch. These components work together under the control of the pre-charging IC to deliver a programmable, constant current charging profile to the high voltage capacitor bank. The use of boundary mode control, as facilitated by the controller's internal logic and the external inductor, allows for rapid charging with minimized power dissipation and reduced stress on system components.

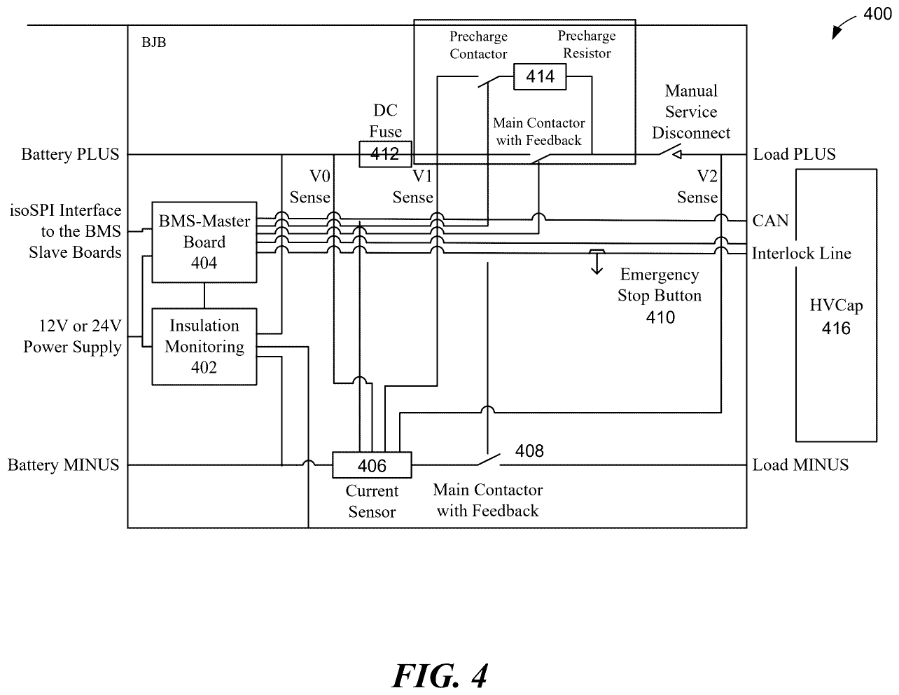

FIG. 4 is a further circuit diagram for a passive pre-charging battery circuit 400. The passive pre-charging battery circuit 400 may include insulation monitoring 402, BMS master board 404, current sensor 406, main contactor with feedback 408, emergency stop button 410, DC fuse 412, precharge resistor 414 and HVCap 416.

The passive pre-charging circuit 400 may be a high voltage resistor, often referred to as the pre-charge resistor. This resistor is connected in series between the high voltage battery (or power source) and the capacitive load. The primary function of this resistor is to limit the initial charging current to a safe value, thereby preventing excessive current flow that could otherwise damage the capacitor, contactors, or other sensitive components in the system. The value of the pre-charge resistor is carefully selected based on the system's voltage, the capacitance of the load, and the desired pre-charging time constant

In addition to the pre-charge resistor, the circuit typically includes a main contactor (or relay) and a pre-charge contactor. During the initial power-up sequence, the pre-charge contactor closes first, allowing current to flow from the high voltage source through the pre-charge resistor and into the capacitor. This controlled current gradually charges the capacitor, with the voltage across the capacitor rising exponentially according to the RC time constant defined by the resistor and the capacitance.

Once the voltage across the capacitor approaches the supply voltage-typically after a predetermined time or when a voltage threshold is detected—the main contactor is closed. This action effectively bypasses the pre-charge resistor, allowing the full system current to flow directly from the high voltage source to the load without the current-limiting effect of the resistor. At this point, the pre-charge contactor may be opened or left closed, depending on the specific system design.

The passive pre-charging process may rely on the physical properties of the resistor and capacitor to control the charging profile. However, the passive pre-charging process may result in significant power dissipation within the pre-charge resistor, especially during the initial charging phase. Also, the resistor may be rated to handle the thermal load associated with this energy dissipation, which can lead to the use of bulky and expensive components.

While passive pre-charging may be relatively straightforward, there may be several limitations. The charging time may be determined by the RC time constant and cannot be easily adjusted without changing component values. Additionally, the energy lost as heat in the pre-charge resistor reduces overall system efficiency. The use of mechanical contactors introduces wear and potential reliability concerns over time, as these components are subject to arcing and mechanical fatigue.

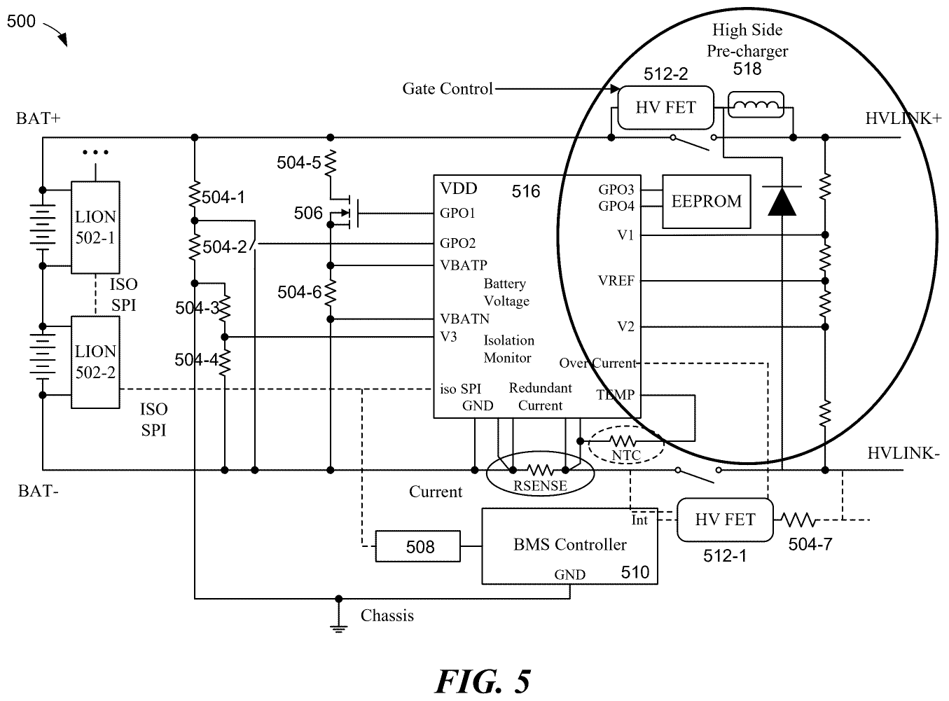

FIG. 5 is a further circuit diagram of an active pre-charging system 500. The active pre-charging a battery system 500 may include various circuitry components as laid out in FIG. 5 such as lithium ion components LION 502-1 and 502-2, resistors 504-1 to 504-7, transistor 506, pre-charge controller IC 516, high side pre-charger 518, sapphire 508, battery management system (BMS) controller 510, HV FET 512. The high side pre-charger 518 may include an high voltage field effect transistor (HV FET), EEPROM, a number of resistors, diode, switches, and an inductor as shown in FIG. 5. The active pre-charging system 500 includes a battery side (BAT+ and BAT−) as well as a high voltage load (HVLINK+ and HVLINK−).

The active pre-charging system 500 represents an integrated approach to managing inrush current for high voltage and capacitive loads, such as those found in EV and HEV battery systems. Unlike passive methods, the active pre-charging circuit leverages a control IC, smart gate drivers, and advanced sensing and protection features to optimize charging time, enhance safety, and improve system reliability.

The active pre-charging system 500 may include the integrated pre-charger controller IC 516, which controls the entire pre-charging process. The pre-charger controller IC 516 includes a set of pins and functions, including VDD (power supply), multiple general-purpose outputs (GPO1, GPO2, GPO3, GPO4), battery voltage sense inputs (VBATP, VBATN), reference voltages (VREF, V1, V2, V3), ISO SPI (isolated serial peripheral interface for communication), GND (ground), TEMP (temperature monitoring), and dedicated pins for overcurrent detection. The pre-charger controller IC 516 may be configured to monitor system voltages, controlling the gate of the high voltage FET, and providing real-time diagnostics and fault indications

The high side pre-charger circuit 518 may include a high voltage FET (HV FET), which acts as the main switching element to control the flow of current from the high voltage battery to the capacitive load. The smart gate driver, integrated within the pre-charge controller IC 516, ensures precise and safe operation of the FET, with features such as DESAT protection (to detect desaturation and prevent FET damage), Miller clamp protection (to avoid unintended turn-on), and adjustable under-voltage lockout (UVLO) for robust operation across different FET technologies, including SiC, Si-MOSFET, and IGBT.

A current sense resistor (RSENSE) is placed in series with the charging path to provide accurate current measurement. The pre-charge controller IC 516 uses this feedback to implement programmable current control, allowing for customized charging profiles and faster, safer pre-charging. The circuit also includes an NTC (Negative Temperature Coefficient) thermistor, which monitors the temperature of critical components, enabling the pre-charge controller IC 516 to take protective action in the event of overheating.

The active pre-charging circuit 500 may be integrated with the BMS controller 510, which oversees the overall health and operation of the battery pack. The BMS controller 510 communicates with the pre-charger controller IC 516 via the ISO SPI interface, exchanging data related to voltage, current, temperature, and fault status. This integration ensures that the pre-charging process may be coordinated with the broader battery management strategy, enhancing both safety and performance.

The circuit diagram also features connections to LION 502-1 and 502-2, circuit component 508, and EEPROM (Electrically Erasable Programmable Read-Only Memory). The EEPROM is used to store configuration parameters, calibration data, and fault logs, enabling the system to retain information across power cycles and support diagnostics.

During the pre-charging process, the pre-charger controller IC 516 may initiate the controlled turn-on of the HV FET 512-1 and 512-2, allowing current to flow from the LION battery through the RSENSE and into the capacitive load. The IC actively monitors the voltage across the load (using VBATP and VBATN), the current through RSENSE, and the temperature via the NTC. It dynamically adjusts the gate drive to the HV FET to maintain a constant charging current, significantly reducing charging time compared to passive methods. The pre-charger controller IC 516 also monitors for overcurrent, overvoltage, undervoltage, and thermal faults, and can immediately disable the pre-charging process if unsafe conditions are detected.

The BMS controller 510 provide additional system-level oversight, ensuring that the pre-charging operation is consistent with the overall battery management and safety protocols. The use of multiple GPOs (general-purpose outputs) allows the pre-charger controller IC 516 to interface with other system components, such as relays, indicators, or additional protection circuits.

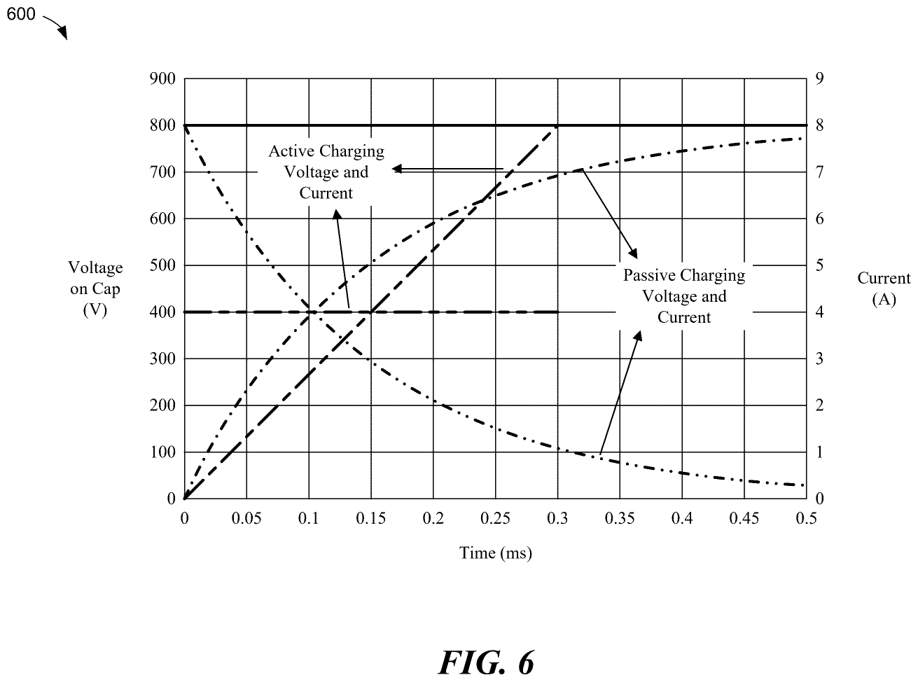

FIG. 6 is a graph diagram 600 showing the difference between a passive and active charging. The graph diagram 600 provides a comparative analysis of passive versus active pre-charging methods in high voltage systems, with a particular focus on the voltage and current profiles over time. The horizontal axis of the graph represents time in milliseconds, ranging from 0 to 0.5 ms, while the vertical axis appears to represent both voltage and current, with a scale extending from 0 to 900. Although the exact units are not specified, the context suggests these values correspond to either millivolts or milliamps.

Within the graph diagram 600, two distinct curves are presented: one for active pre-charging and one for passive pre-charging. The active pre-charging curve rises sharply, reaching the target voltage or current much more rapidly than the passive method. This steep ascent may indicate a quick charging process characterized by a controlled, constant current profile. In contrast, the passive pre-charging curve increases more gradually, taking significantly longer to reach the same voltage or current level. The less steep slope of the passive curve may reflect the inherent limitations of passive components, such as resistors and contactors, which result in a slower charging process

The graph diagram 600 demonstrates that active pre-charging achieves a substantial reduction in charging time, with the data indicating up to a 60% faster process compared to passive pre-charging. This improvement may be evident from the earlier and steeper rise of the active charging curve. Furthermore, the active pre-charging method maintains a more constant current throughout the charging process, which enhances both speed and safety. In contrast, the passive method exhibits a less controlled current profile, leading to inefficiencies and extended charging times

The area under the active charging curve reaches its maximum value much sooner than the passive curve, signifying that the system attains its operational voltage or current threshold more quickly and efficiently. By reducing inrush current and precisely controlling the charging profile, active pre-charging also minimizes stress on system components, a benefit not as effectively realized with passive approaches. Overall, the graph diagram 600 serves as a visual representation of the performance improvements offered by active pre-charging controllers, illustrating faster charging times, improved current control, and enhanced system safety. These advantages are particularly critical for modern electric vehicle, hybrid electric vehicle, and other high voltage applications

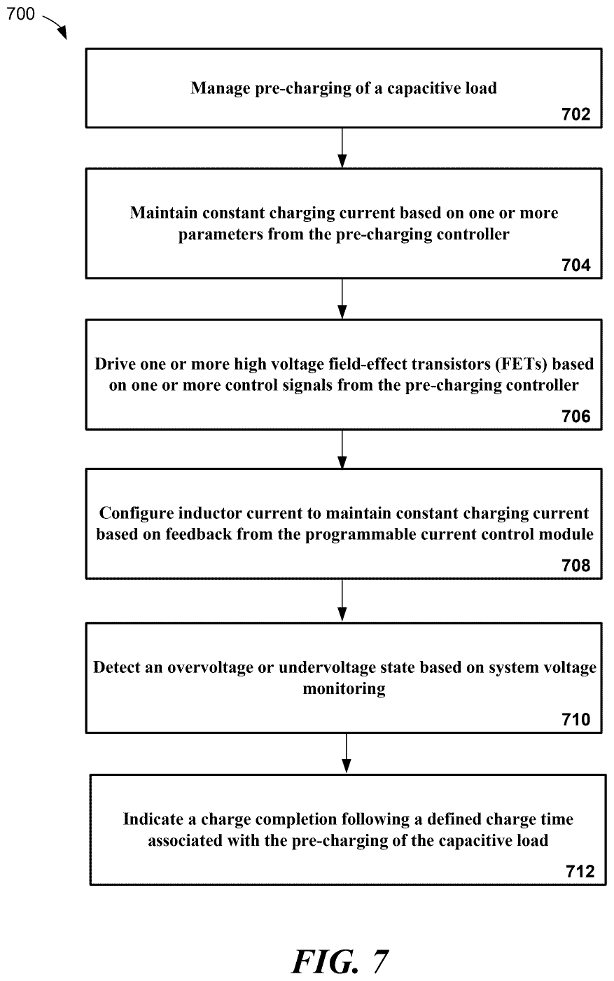

FIG. 7 is a flowchart of an example of pre-charging a battery system. Specifically, the flow chart sets forth an example of a method 700 for pre-charging a battery system, such as in pre-charging battery system 100, 200, 300, 400 and 500. In an example, the pre-charging battery system can perform the functions described in method 700 using one or more of the components and techniques described in FIGS. 1-5, such as via execution of one or more components described herein, individually or in combination

At block 702, the method 700 may manage pre-charging of a capacitive load. In an aspect, the pre-charging a battery system 100, 300, 400, and/or 500, e.g., in conjunction with the pre-charge controller IC 104, 160, 200, 280, 302, 400, and/or 516 and/or may be configured to manage pre-charging of a capacitive load. Thus, the pre-charging a battery system 100, 300, 400, and/or 500, or one of its subcomponents may define the means for managing pre-charging of a capacitive load.

At block 704, the method 700 may maintain constant charging current based on one or more parameters from the pre-charging controller. In an aspect, the pre-charging a battery system 100, 300, 400, and/or 500, e.g., in conjunction with the pre-charge controller IC 104, 160, 200, 280, 302, 400, and/or 516 and/or may be configured to maintain constant charging current based on one or more parameters from the pre-charging controller. Thus, the pre-charging a battery system 100, 300, 400, and/or 500, or one of its subcomponents may define the means for maintaining constant charging current based on one or more parameters from the pre-charging controller.

At block 706, the method 700 may drive one or more high voltage FETs based on one or more control signals from the pre-charging controller. In an aspect, the pre-charging a battery system 100, 300, 400, and/or 500, e.g., in conjunction with the pre-charge controller IC 104, 160, 200, 280, 302, 400, and/or 516 and/or may be configured to drive one or more high voltage FETs based on one or more control signals from the pre-charging controller. Thus, the pre-charging a battery system 100, 300, 400, and/or 500, or one of its subcomponents may define the means for driving one or more high voltage FETs based on one or more control signals from the pre-charging controller.

At block 708, the method 700 may configure inductor current to maintain constant charging current based on feedback from the programmable current control module. In an aspect, the pre-charging a battery system 100, 300, 400, and/or 500, e.g., in conjunction with the pre-charge controller IC 104, 160, 200, 280, 302, 400, and/or 516 and/or may be configured to configure inductor current to maintain constant charging current based on feedback from the programmable current control module. Thus, the pre-charging a battery system 100, 300, 400, and/or 500, or one of its subcomponents may define the means for configuring inductor current to maintain constant charging current based on feedback from the programmable current control module.

At block 710, the method 700 may detect an overvoltage or undervoltage state based on system voltage monitoring. In an aspect, the pre-charging a battery system 100, 300, 400, and/or 500, e.g., in conjunction with the pre-charge controller IC 104, 160, 200, 280, 302, 400, and/or 516 and/or may be configured to detect an overvoltage or undervoltage state based on system voltage monitoring. Thus, the pre-charging a battery system 100, 300, 400, and/or 500, or one of its subcomponents may define the means for detecting an overvoltage or undervoltage state based on system voltage monitoring.

At block 712, the method 700 may indicate a charge completion following a defined charge time associated with the pre-charging of the capacitive load. In an aspect, the pre-charging a battery system 100, 300, 400, and/or 500, e.g., in conjunction with the pre-charge controller IC 104, 160, 200, 280, 302, 400, and/or 516 and/or may be configured to indicate a charge completion following a defined charge time associated with the pre-charging of the capacitive load. Thus, the pre-charging a battery system 100, 300, 400, and/or 500, or one of its subcomponents may define the means for indicating a charge completion following a defined charge time associated with the pre-charging of the capacitive load.

In some implementations, the smart gate driver module may further configured to provide adjustable undervoltage lockout, desaturation protection, and Miller clamp protection. In some implementations, the timing module may further configured to generate a fault indication if the pre-charging of the capacitive load is not completed within a predetermined time period.

In some implementations, the programmable current control module is further configured to adjust the charging current limit to accommodate a different capacitor size and charging profile. In some implementations, the smart gate driver includes desaturation (DESAT) protection to prevent operational failure during a switching event.

In some implementations, the boundary mode controller is further configured to determine an off-time for one or more switching cycles by actively monitoring the voltage across an inductor. In some implementations, the safety monitoring module further comprises a built-in self-test (BIST).

In some implementations, the timing module includes a programmable extended charge time fault indicator that disables the pre-charging controller if charging is not completed within a specified period. In some implementations, the charge complete indication is transmitted through a dedicated output pin.

In some implementations, the pre-charging controller is further configured to terminate charging upon detection of a completed charge based on output voltage monitoring. In some implementations, the smart gate driver is further configured to provide a peak source and sink current of at least 2 A.

In some implementations, the pre-charging controller is further configured to operate at a switching frequency of up to 100 kHz. In some implementations, the IC further includes a dedicated enable (EN) pin and a dedicated fault (FLT) pin for external pre-charge control. In some implementations, the safety monitoring module further comprises a redundant bandgap reference for providing fault-tolerant overvoltage and undervoltage detection.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements may be physical, logical, or a combination thereof. As used herein, two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” and “e.g.” are utilized herein to mean serving as an instance or illustration. Any aspect or design described herein as an “example” or referred to in connection with a “such as” clause or “e.g.” is not necessarily to be construed as preferred or advantageous over other aspects or designs described herein. Rather, use of the terms “example” or “such as” or “e.g.” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using special programming as described herein. In addition, various of the aspects disclosed herein also can be implemented by means of program modules or other types of computer program instructions specially configured as described herein and stored in a memory device and executed individually or in combination by one or more processors, or other combination of hardware and software, or hardware and firmware. Such specially configured program modules or computer program instructions, as described herein, can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any non-transitory computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. An integrated circuit for active pre-charging in high voltage battery systems, comprising:
a pre-charging controller configured to manage pre-charging of a capacitive load;
a programmable current control module configured to maintain constant charging current based on one or more parameters from the pre-charging controller;
a smart gate driver configured to drive one or more high voltage field-effect transistors (FETs) based on one or more control signals from the pre-charging controller;
a boundary mode controller configured to configure inductor current to maintain constant charging current based on feedback from the programmable current control module;
a safety monitoring module configured to detect an overvoltage or undervoltage state based on system voltage monitoring; and
a timing module configured to indicate a charge completion following a defined charge time associated with the pre-charging of the capacitive load.

2. The integrated circuit of claim 1, wherein the smart gate driver module is further configured to provide adjustable undervoltage lockout, desaturation protection, and Miller clamp protection.

3. The integrated circuit of claim 1, wherein the timing module is further configured to generate a fault indication if the pre-charging of the capacitive load is not completed within a predetermined time period.

4. The integrated circuit of claim 1, wherein the programmable current control module is further configured to adjust the charging current limit to accommodate a different capacitor size and charging profile.

5. The integrated circuit of claim 1, wherein the smart gate driver includes desaturation (DESAT) protection to prevent operational failure during a switching event.

6. The integrated circuit of claim 1, wherein the boundary mode controller is further configured to determine an off-time for one or more switching cycles by actively monitoring the voltage across an inductor.

7. The integrated circuit of claim 1, wherein the safety monitoring module further comprises a built-in self-test (BIST).

8. The integrated circuit of claim 1, wherein the timing module includes a programmable extended charge time fault indicator that disables the pre-charging controller if charging is not completed within a specified period.

9. The integrated circuit of claim 1, wherein the charge complete indication is transmitted through a dedicated output pin.

10. The integrated circuit of claim 1, wherein the pre-charging controller is further configured to terminate charging upon detection of a completed charge based on output voltage monitoring.

11. The integrated circuit of claim 1, wherein the smart gate driver is further configured to provide a peak source and sink current of at least 2 A.

12. The integrated circuit of claim 1, wherein the pre-charging controller is further configured to operate at a switching frequency of up to 100 kHz.

13. The integrated circuit of claim 1, further comprising a dedicated enable (EN) pin for external pre-charge control.

14. The integrated circuit of claim 1, further comprising a dedicated fault (FLT) pin for external diagnostics.

15. The integrated circuit of claim 1, wherein the safety monitoring module further comprises a redundant bandgap reference for providing fault-tolerant overvoltage and undervoltage detection.

16. A method of pre-charging in high voltage battery systems, comprising:
managing pre-charging of a capacitive load;
maintaining constant charging current based on one or more parameters from the pre-charging controller;
driving one or more high voltage field-effect transistors (FETs) based on one or more control signals from the pre-charging controller;
configuring inductor current to maintain constant charging current based on feedback from the programmable current control module;
detecting an overvoltage or undervoltage state based on system voltage monitoring; and
indicating a charge completion following a defined charge time associated with the pre-charging of the capacitive load.

17. The method of claim 1, wherein driving one or more FETs further includes providing adjustable undervoltage lockout, desaturation protection, and Miller clamp protection.

18. The method of claim 1, further comprising generating a fault indication if the pre-charging of the capacitive load is not completed within a predetermined time period.

19. The method of claim 1, further comprising adjusting the charging current limit to accommodate a different capacitor size and charging profile.

20. An apparatus for active pre-charging in high voltage battery systems, comprising:
means for managing pre-charging of a capacitive load;
means for maintaining constant charging current based on one or more parameters from the pre-charging controller;
means for driving one or more high voltage field-effect transistors (FETs) based on one or more control signals from the pre-charging controller;
means for configuring inductor current to maintain constant charging current based on feedback from the programmable current control module;
means for detecting an overvoltage or undervoltage state based on system voltage monitoring; and
means for indicating a charge completion following a defined charge time associated with the pre-charging of the capacitive load.
